(19) United States
(12) Patent Application Publication
(10) Pub. No.: US 2012/0104077 A1
(43) Pub. Date: May 3, 2012

(54) AUTOMATIC SOLDERING APPARATUS AND SOLDERING METHOD THEREOF

(75) Inventors: JI-DONG TIAN, Tu Cheng (TW); Xiao-Iin Wu, Tu Cheng (TW); Sung-Iin Chen, Tu Cheng (TW); Shao-bo Zhang, Tu Cheng (TW)

(73) Assignee: Cheng Uei Precision Industry Co., LTD., Tu Cheng City (TW)

(21) Appl. No.: 12/916,529

(22) Filed: Oct. 30, 2010

(51) Int. Cl. B23K 31/02; B23K 37/04

(52) U.S. Cl. 228/212; 228/44.3

(57) ABSTRACT

An automatic soldering apparatus and a soldering method thereof are provided. The soldering method has steps of: (S1) positioning a to-be-soldered part and an electronic component having a solder material; (S2) driving a hot press to firstly move, until the hot press is in contact with the part; (S3) heating the solder material by the hot press; and (S4) driving the hot press to secondly move to press the solder material after the solder material on the electronic component is melted, so as to connect the part to the melted solder material on the electronic component by soldering. When the automatic soldering apparatus and the soldering method of the present invention are used to execute a soldering process, a route of the hot press can be controlled to firstly melt the solder material and then deform it, so as to avoid the hot press from impacting and damaging the part.

### FIELD OF THE INVENTION

The present invention relates to a soldering technology, and more particularly to an automatic soldering apparatus and a soldering method of the automatic soldering apparatus.

### BACKGROUND OF THE INVENTION

Nowadays, a traditional soldering apparatus generally comprises a base, a cylinder used as a driving unit and a hot press. When the traditional soldering apparatus is used to connect a first electronic component to a second electronic component by a solder material, the cylinder is generally used to generate an impact force to the hot press and the first electronic component once, and thus the hot press and the first electronic component can press the solder material to deform the solder material up to a certain degree prior to heating the solder material, for the purpose of firmly soldering.

However, when the traditional soldering apparatus is used to execute a soldering process, the impact force of the cylinder deforms the solder material prior to heating it, so that the first electronic component may be easily damaged due to the impact force.

### SUMMARY OF THE INVENTION

A primary object of the present invention is to provide an automatic soldering apparatus and a soldering method thereof, which can avoid from damaging one of electronic components during soldering, and thus can overcome the disadvantages existing in the conventional technologies, as described above.

To achieve the above object, the present invention provides an automatic soldering apparatus which comprises a base, a driving unit, a hot press and a control device, wherein the driving unit is mounted on the base, and has a stepping motor and a screw transmission mechanism connected to the stepping motor. Moreover, the screw transmission mechanism has a screw driven by the stepping motor and a sliding block driven by the screw. The hot press is mounted on the sliding block. The control device is electrically connected to the stepping motor for controlling the stepping motor to work and thus drive the hot press on the sliding block to move in a stepping manner.

Furthermore, to achieve the above object, the present invention further provides a soldering method of an automatic soldering apparatus, and the soldering method comprises the following steps of:

(S1) positioning a to-be-soldered part and an electronic component having a solder material;

(S2) driving a hot press to firstly move, until the hot press is in contact with the part;

(S3) heating the solder material by the hot press; and

(S4) driving the hot press to secondly move to press the solder material through the part after the solder material on the electronic component is melted, so as to connect the part to the melted solder material on the electronic component by soldering, such that a complete connection between the part and the electronic component soldered by the solder material is carried out.

As described above, when the automatic soldering apparatus and the soldering method of the present invention are used to execute a soldering process, a route of the hot press can be controlled to firstly melt the solder material and then deform it, so as to avoid the hot press from impacting and damaging the part.

### DESCRIPTION OF THE DRAWINGS

FIG. 1 is a schematic view of a hot press of a soldering method according to a preferred embodiment of the present invention, wherein the hot press firstly moves to be in contact with a to-be-soldered part;

FIG. 2 is another schematic view of the hot press of the soldering method according to the preferred embodiment of the present invention, wherein a solder material is melted and then the hot press secondly moves to press the melted solder wire for connecting the part to an electronic component by soldering;

FIG. 3 is a partially perspective view of an automatic soldering apparatus according to the preferred embodiment of the present invention;

FIG. 4 is an exploded perspective view of a driving unit of the automatic soldering apparatus in FIG. 3 according to the preferred embodiment of the present invention; and

FIG. 5 is a perspective view of a clamping unit of the automatic soldering apparatus according to the preferred embodiment of the present invention.

### DETAILED DESCRIPTION OF THE PREFERRED EMBODIMENTS

The structure and the technical means adopted by the present invention to achieve the above and other objects can be best understood by referring to the following detailed description of the preferred embodiments and the accompanying drawings. Furthermore, directional terms described by the present invention, such as upper, lower, front, back, left, right, inner, outer, side and etc., are only directions by referring to the accompanying drawings, and thus the used directional terms are used to describe and understand the present invention, but the present invention is not limited thereto.

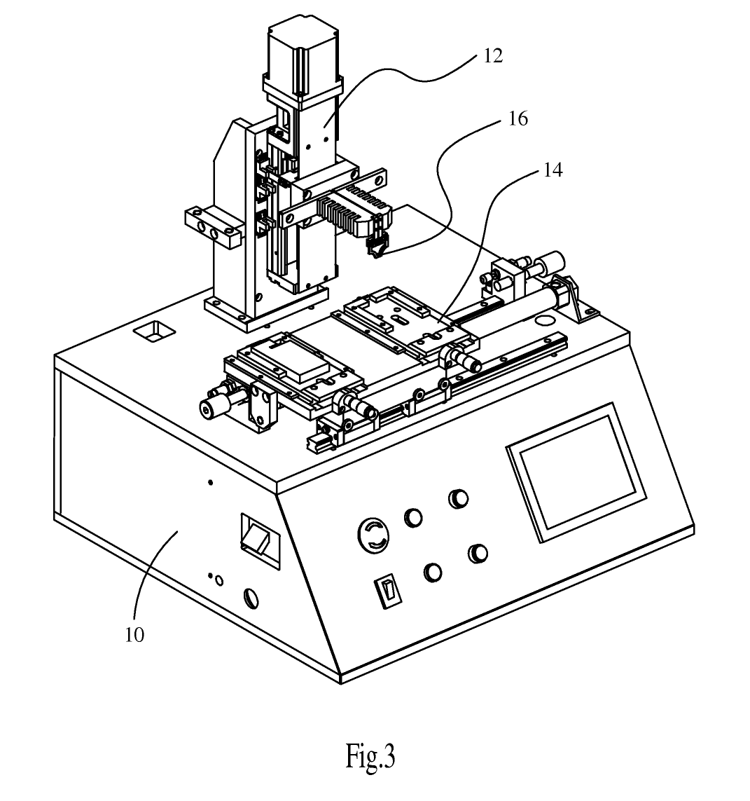

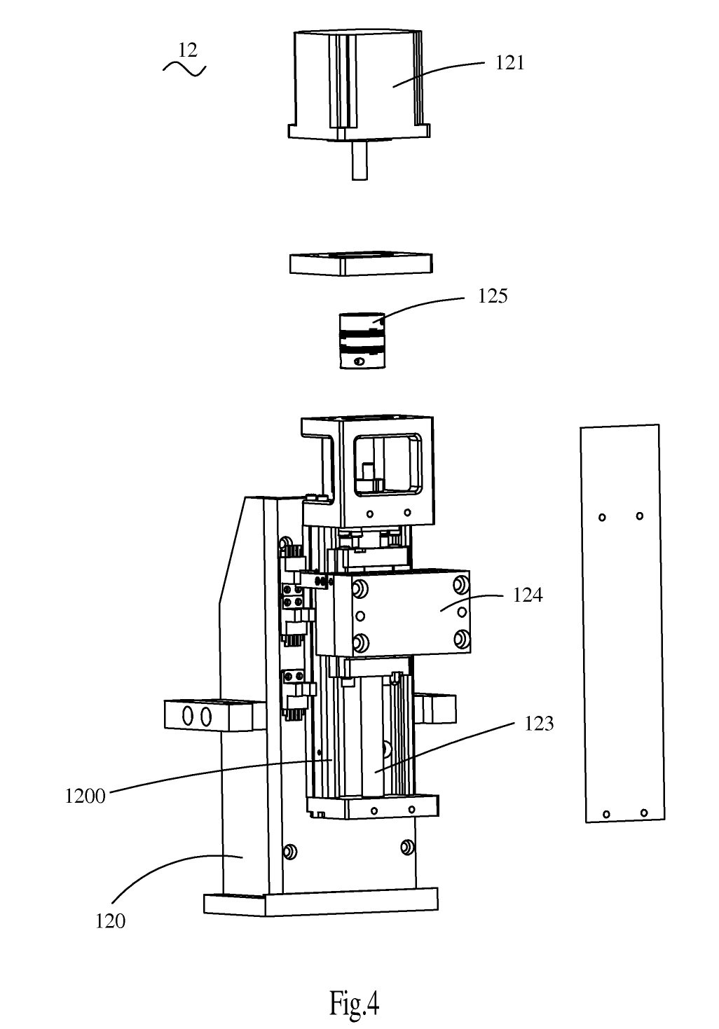

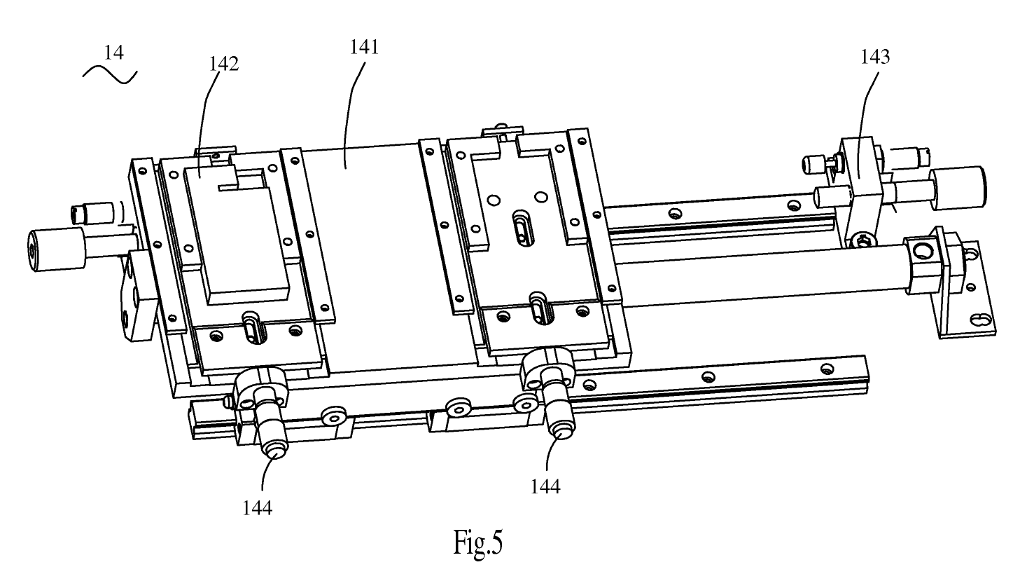

Referring now to FIGS. 3, 4 and 5, an automatic soldering apparatus according to a preferred embodiment of the present invention is illustrated. As shown, the automatic soldering apparatus comprises a control device (not-shown), a base 10, a driving unit 12 installed on the base 10, a clamping unit 14 and a hot press 16. The driving unit 12 includes a holder 120 mounted on the base 10, a stepping motor 121, a coupling unit 125 and a screw transmission mechanism connected to the stepping motor 121, wherein the screw transmission mechanism includes a screw 123 driven by the stepping motor 121 and a sliding block 124 driven by the screw 123. The holder 120 is provided with a pair of guiding rails 1200. The stepping motor 121 is mounted on the holder 120, and the screw 123 is axially connected to a bottom of the stepping motor 121 through the coupling unit 125. The sliding block 124 is sleeved on the screw 123, and can be moved along the guiding rails 1200 according to the rotation of the screw 123. The clamping unit 14 includes a working table 141, a clamping tool 142 positioned on the working table 141 and a position adjusting device 143 for driving the working table 141 to move leftward or rightward. The working table 141 further includes two correction devices 144 in front of the clamping tool 142 for correcting the position of the clamping tool 142 forward or backward.

The hot press 16 is mounted on the sliding block 124. The control device is electrically connected to the stepping motor 121 for controlling the stepping motor 121 to work and thus drive the screw 123 to rotate, so as to drive the hot press 16 on the sliding block 124 to move downward in a stepping manner.

The hot press 16 is further provided with a temperature sensor (not-shown) electrically connected to the control device, wherein the temperature sensor detects the temperature of the hot press 16, and immediately feeds back to the control device, so that the control device can adjust the real-time temperature of the hot press 16 into an optimized temperature value for ensuring the soldering quality.

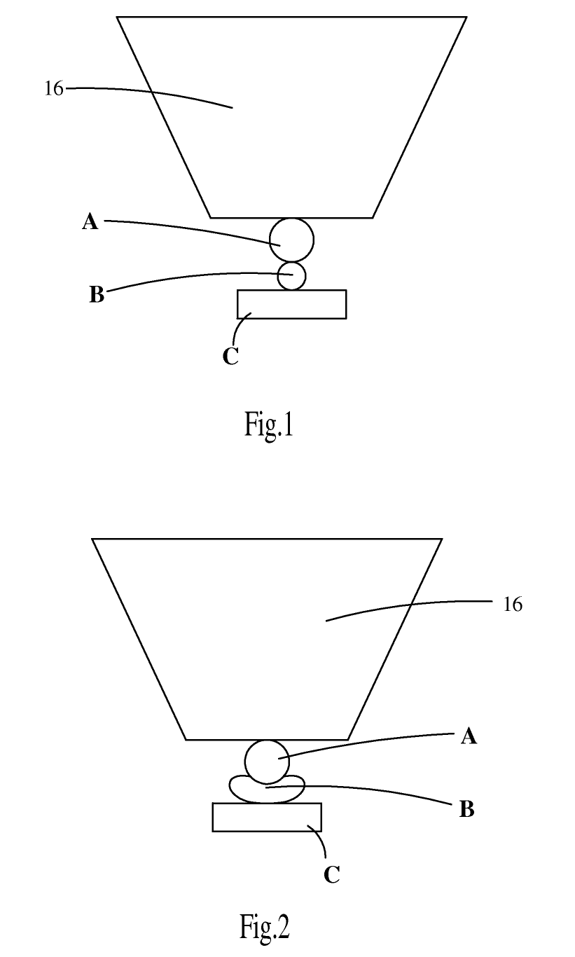

Referring now to FIGS. 1 and 2, a soldering method using the automatic soldering apparatus according to the preferred embodiment of the present invention comprises the following steps of:

(S1) positioning a to-be-soldered part A and an electronic component C having a solder material B;

(S2) driving a hot press 16 to firstly move, until the hot press 16 is in contact with the part A;

(S3) heating the solder material B by the hot press 16; and

(S4) driving the hot press 16 to secondly move to press the solder material B through the part A after the solder material B on the electronic component C is melted, so as to connect the part A to the melted solder material B on the electronic component C by soldering, such that a complete connection between the part A and the electronic component C soldered by the solder material B is carried out.

Referring now to FIGS. 3, 4 and 5, in the foregoing soldering method, the hot press 16 is driven to move by the stepping motor 121 and the screw transmission mechanism connected to the stepping motor 121. The temperature of the hot press 16 is detected and fed back to a control device by the temperature sensor, so that the control device can adjust the real-time temperature of the hot press 16 into an optimized temperature value for ensuring the soldering quality.

Referring still to FIGS. 3, 4 and 5, before the automatic soldering apparatus of the present invention works, an electronic component C is firstly mounted on a clamping tool 142, and then the clamping tool 142 is positioned on the working table 141. The position adjusting device 143 of the clamping unit 14 adjusts the horizontal position of the working table 141, until a to-be-soldered portion of the electronic component C in the clamping tool 142 on the working table 141 is aligned with the hot press 16 above the electronic component C in the horizontal direction. Then, the correction devices 144 correct the vertical position of the clamping tool 142 on the working table 141, so that the to-be-soldered portion of the electronic component C is aligned with the hot press 16 above the electronic component C in the vertical direction. After this, the steps of the foregoing soldering method will be executed for soldering, i.e. comprising the following steps of:

(S1) positioning the to-be-soldered part A and the electronic component C with the solder material B on the clamping tool 142, and placing the clamping tool 142 under the hot press 16 and positioning the clamping tool 142;

In the embodiment, the part A is a wire, the solder material B is a solder wire having a diameter of 0.65 mm. After a plurality of tests, the optimized distance of the secondly motion of the hot press 16 is set to 0.4 mm.

(S2) driving the hot press 16 to firstly move, until the hot press 16 is in contact with the part A;

(S3) sending a command from the control device to raise the temperature of the hot press 16 for heating the solder wire;

(S4) driving the hot press 16 to secondly move to press the solder wire through the part A after the solder wire on the electronic component C is melted, so as to connect the part A to the melted solder wire on the electronic component C by soldering, such that a complete connection between the part A and the electronic component C soldered by the solder material B is carried out; and

(S5) lowering the temperature of the hot press 16, the part A and the electronic component C with the solder material B, and then controlling the driving unit 12 by the control device, so as to drive the hot press 16 to move upward away from the part A and the electronic component C. Thus, the soldering process of the part A and the electronic component C is finished.

During the entire soldering process, the temperature sensor detects the temperature of the hot press 16 and immediately feeds back to the control device, so that the control device can adjust the real-time temperature of the hot press 16 into an optimized temperature value for ensuring the soldering quality.

As described above, when the automatic soldering apparatus and the soldering method of the present invention are used to execute a soldering process, a route of the hot press 16 can be controlled to firstly melt the solder material B and then deform the solder material B, so as to avoid the hot press 16 from impacting and damaging the part A.

The present invention has been described with a preferred embodiment thereof and it is understood that many changes and modifications to the described embodiment can be carried out without departing from the scope and the spirit of the invention that is intended to be limited only by the appended claims.

What is claimed is:

1. An automatic soldering apparatus, comprising:
a base;
a driving unit mounted on the base, and having a stepping motor and
a screw transmission mechanism connected to the stepping motor;
wherein the screw transmission mechanism has a screw driven by the stepping motor and a sliding block driven by the screw;
a hot press mounted on the sliding block; and
a control device electrically connected to the stepping motor for controlling the stepping motor to work and thus drive the hot press on the sliding block to move in a stepping manner.

2. The automatic soldering apparatus according to claim 1, further comprising a clamping unit which includes a working table, a clamping tool positioned on the working table, a position adjusting device for driving the working table to move leftward or rightward, and correction devices mounted on the working table for correcting the position of the clamping tool forward or backward.

3. The automatic soldering apparatus according to claim 1, wherein the hot press is further provided with a temperature sensor electrically connected to the control device.

4. A soldering method of an automatic soldering apparatus, comprising steps of:
(S1) positioning a to-be-soldered part and an electronic component having a solder material;
(S2) driving a hot press to firstly move, until the hot press is in contact with the part;
(S3) heating the solder material by the hot press; and
(S4) driving the hot press to secondly move to press the solder material through the part after the solder material on the electronic component is melted, so as to connect the part to the melted solder material on the electronic component by soldering, such that a complete connection between the part and the electronic component soldered by the solder material is carried out.

5. The soldering method of an automatic soldering apparatus according to claim 4, wherein the hot press is further driven to move by a stepping motor and a screw transmission mechanism connected to the stepping motor.
